(19) United States
(12) Patent Application Publication
(10) Pub. No.: US 2003/0094785 A1
(43) Pub. Date: May 22, 2003

(54) Hitch centering guide and protection device

(76) Inventor: Richard Woods, Sandy, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 10/271,969

(22) Filed: Oct. 15, 2002

Related U.S. Application Data
(60) Provisional application No. 60/329,720, filed on Oct. 16, 2001.

(51) Int. Cl. B60D 1/00

(52) U.S. Cl. 280/477

(57) ABSTRACT

A trailer tongue centering guide having a base with a first aperture through which a ball connector may be secured to a tow bar through the first aperture and a pair of guide walls rigidly secured perpendicular to the top surface of the base at oblique angles to the first aperture and defining a second aperture essentially perpendicular to the first aperture through which the tow bar may be inserted such that the tow bar is positioned parallel to the top surface of the base and the ball connector may be positioned over the first aperture.

### RELATED APPLICATION

This application claims the benefit of U.S. Provisional Application No. 60/329,720, filed Oct. 16, 2001 and entitled “HIGH CENTERING GUIDE AND PROTECTION DEVICE,” incorporated herein by reference.

### BACKGROUND

1. The Field of the Invention

This invention relates to a center guide, and more particularly to an apparatus for centering a trailer tongue over a hitch.

2. The Background Art

Backing up a vehicle to align the tongue of a trailer with a hitch, such as a pin and aperture, pintle, or bal can be frustrating and cumbersome. Trailers are often heavy and unwieldy, and unless the vehicle is placed in precisely in the right place, people have to wrestle the tongue of the trailer into place and lower it onto the ball. Aligning a tow bar and ball beneath the accompanying tongue of a trailer can also be expensive if the vehicle overshoots its goal and the trailer impacts the bumper. This is especially true with today's plastic or rubber bumpers.

There have been attempts to assist in the centering ofthe trailer tongue over the ball/tow bar assembly of a vehicle. Some attempts include side walls which guide the trailer tongue to a position over the ball as the vehicle, with its tow bar and ball, move towards the tongue ofthe trailer. Many of these attempts have significant shortcomings however. One such shortcoming is that the centering device is allowed to pivot relative to the vehicle. When the trailer tongue first engages these devices, the walls of such devices act as a lever, causing the device to pivot to move to a more perpendicular position relative to the trailer tongue, thus negating the device's ability to guide the tongue over the ball hitch. This can often occur even if the centering device is bolted down to the tow bar by the threaded ball joint.

Another problem with many prior art centering devices is that they are cumbersome or difficult to use. For example, some prior art trailer tongue guides have multiple parts of substantial weight and complexity, which must be assembled and disassembled each time the device is used. These parts are susceptible to loss, misalignment, binding, and other mechanical failure modes. Either failures or even normal operations can add time to the process of centering the trailer tongue over the ball hitch. Other guides have portions that must be removed after the tongue is centered, but before the tongue can be secured to the ball. This complexity of use reduces the likelihood that the device will be used and adversely affects sales.

Other guides are designed with multiple angles, folds, or creases in the guiding member, which decreases the ability ofthe device to smoothly guide the trailer tongue into position. Other devices have ramps, which increase the chance of damage should the vehicle move too quickly and the trailer tongue jump off the ramp and into the back of vehicle. Lifting the trailer off the ground also provides instability as the force of the trailer must rest on the guide device and a point of contact between the trailer and the ground is removed.

Other guiding or centering devices are expensive to make because they include numerous parts to be fitted together. The price also increases because these multi-piece and complex designs require additional manufacturing steps. Still other designs are of insufficient strength to withstand the torque applied to the device by the weight ofthe trailer and the force ofthe vehicle when the trailer tongue engages a guide member causing the device to pivot. For example, without sufficient support offering resistance to rotational forces caused by a trailer tongue impinging on a single side of a centering system, a centering system bolted down by the mounting bolt of a ball hitch may simply rotate with the force and fail to operate properly.

What is needed is a hitch centering or guidance system easily operable, preferably by a single individual, and effective to guide a trailer tongue to a hitch in a lateral direction, while a driver brings a vehicle and hitch into proximity in a longitudinal direction. Such a system should function to guide the tongue laterally with respect to the vehicle hitch, and capture the tongue in both lateral and longitudinal directions to register the tongue with the hitch. The system should accomplish this without requiring a vehicle operator to leave the vehicle more than once during the entire alignment sequence to make a comparatively gross determination and corresponding correction ofthe relative location of the trailer tongue and vehicle hitch.

### BRIEF SUMMARY OF THE INVENTION

The present invention overcomes these and other problems in the art, and provides such a system as the one desired. Relative locations ofthe tongue and hitch are considered in all three dimensions. Lateral (side-to-side) gross alignment is controlled by vehicle steering, longitudinal (end-to-end) gross alignment is controlled by vehicle movement and braking, and transverse (up-and-down) gross alignment is controlled by the jack associated with support ofthe trailer tongue. Meanwhile, final alignment is controlled in the lateral and longitudinal directions by an apparatus in accordance with the invention, which places the tongue sufficiently close to the hitch to support engagement ofthe tongue and hitch. Final alignment in the transverse direction is controlled by lowering the jack to drop the tongue into engagement with the hitch.

The invention provides an improved hitch centering guide and protection device to aid in the coupling of a trailer to a motor vehicle. The trailer hitch centering guide has a base or base plate with a first opening through which a ball connector may be secured to a tow bar through the first opening and a pair of guide walls rigidly secured perpendicular to the top surface ofthe base at oblique angles to the first opening and defining a second opening essentially perpendicular to the first opening through which the tow bar may be inserted such that the tow bar is positioned parallel to the top surface of the base and the ball connector may be positioned over the first opening.

This new centering guide provides a reliable mechanism for aiding the coupling of a trailer to a motor vehicle. The centering guide will help guide the tongue of a trailer onto the ball connector of a motor vehicle and provide needed and valuable protection to the motor vehicle. The centering guide will also be more durable and reliable than previous devices attempting to perform the same function because this new centering guide eliminates pivoting movement between the centering guide and the tow bar ofthe motor vehicle when the tongue ofthe trailer strikes the guide wall of the centering guide.

### BRIEF DESCRIPTION OF THE DRAWINGS

The foregoing and other advantages and features ofthe present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use ofthe accompanying drawings in which:

FIG. 1 is a front plan view ofthe centering guide from rearward ofthe position where the centering guide would be mounted on a vehicle and a top plan view of the centering guide;

FIG. 2 is a side plan view of an alternative embodiment ofthe centering guide of FIG. 1 showing a lip extension;.

FIG. 3 is a front plan view of a guide wall ofthe centering guide of FIG. 1 showing an opening to accommodating a tow bar and notches to facilitate assembly of the centering guide;

FIG. 4 is a top plan view of a base showing an opening to accommodate a hitch;

FIG. 5a is a top plan view of an alternative embodiment ofthe centering guide of FIG. 1; and

FIG. 5b is atop plan view of another alternative embodiment ofthe centering guide of FIG. 1.

### DETAILED DESCRIPTION OF THE INVENTION

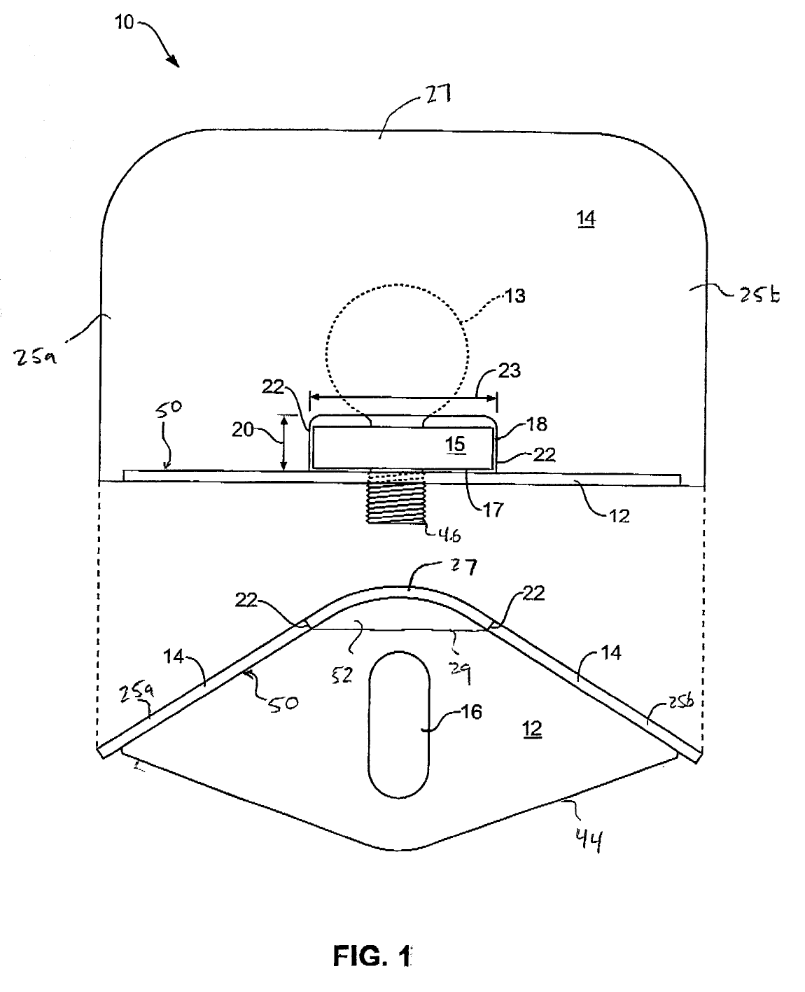

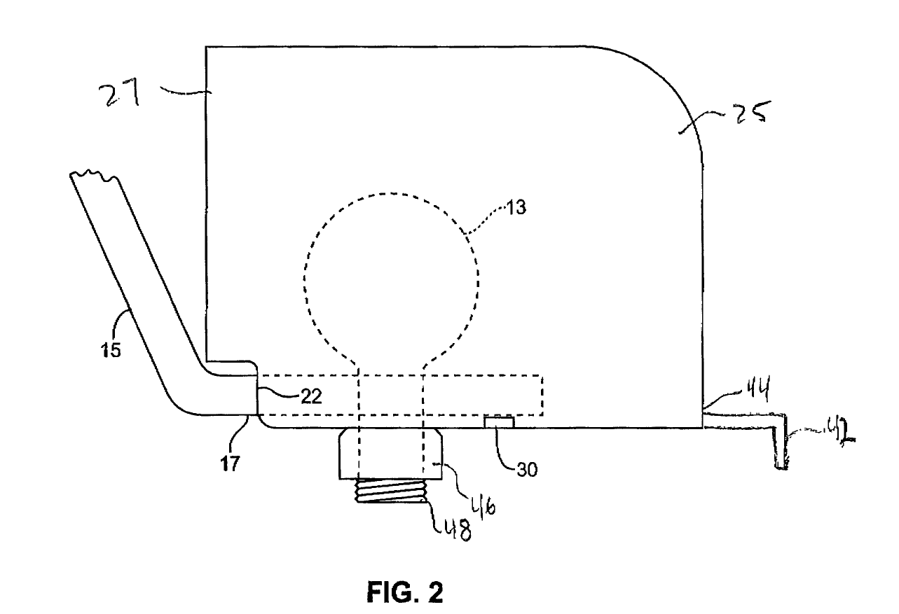

Reference is now made to the figures wherein like parts are referred to by like numerals throughout. With particular reference to FIGS. 1 and 2, the invention relates to a novel guide or trailer tongue centering and protection device 10. The invention includes a base 12 and a guide wall 14 extending upwardly from the base 12. In one embodiment, the guide wall 14 may be integral to form a single guide wall 14. The base 12 includes an opening 16 which allows a towing ball hitch 13 with a tow bar 15 to be adjustable within the opening 16. This allows the device 10 to be slid forward and back until it is secured to the plate 12 at a desired position.

The guide wall 14, along with the base 12 defines an opening 18. The guide wall 14 forms a wide “v” with a smoothly radiused curve connecting tangentially at the apex (vertex) ofthe “v.” The curve is positioned forward ofthe ball 13 between the ball 13 and the remainder ofthe vehicle. The curve preferably has radiuses larger than any radius ofthe tongue ofthe trailer, and thus has a diameter larger than the width ofthe tongue. The tongue contains a mating socket for the ball hitch. The lack of sharp angles allows the device 10 to more easily guide the tongue of a trailer into proper position. With the curved apex ofthe “v” forward ofthe ball, centering the tongue over the ball hitch 13 is easier.

The guide wall 14 may be at a height to provide protection to the bumper ofthe towing vehicle. The opening 18 is positioned adjacent to the base 12 and has a height 20 that allows for a standard tow bar, to which the ball 13 is attached, to be positioned within the opening 18. The opening 18 should also allow clearance for the upward curve of most standard tow bars 15 (see FIG. 2). The opening 18 is partially defined by a pair of edges 22. The edges 22 are spaced apart at a width 23 just slightly wider than the width of the tow bar 15.

In one embodiment, the distance between a side ofthe tow bar 15 and a respective side wall 22 may be less than one quarter of an inch for each side. In another embodiment, the distance between respective sides ofthe tow bar 15 and a respective edges 22 may be less than one eighth of an inch. With the tow bar 15 positioned within the opening 18, the base 12 is attached to an underside 17 ofthe tow bar. In this configuration, the edges 22 act as stops to prevent pivoting of the device 10 about the ball 13. The integral nature ofthe guide wall 14 prevents shearing of the guide wall 14 under the torque of the rotating device 10 under the force of a trailer tongue impacting the guide wall 14.

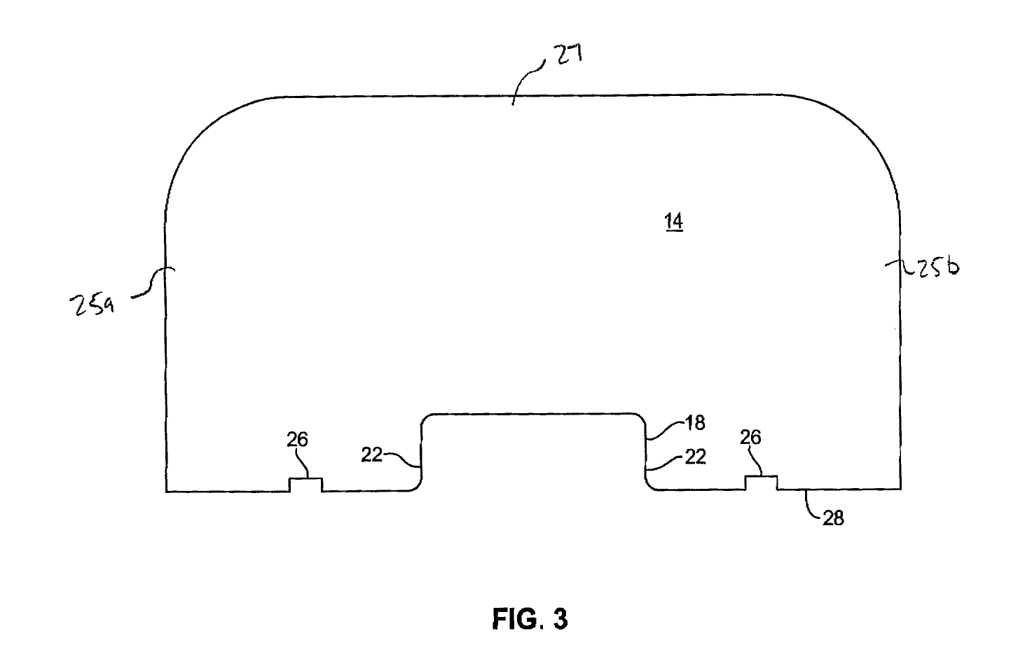

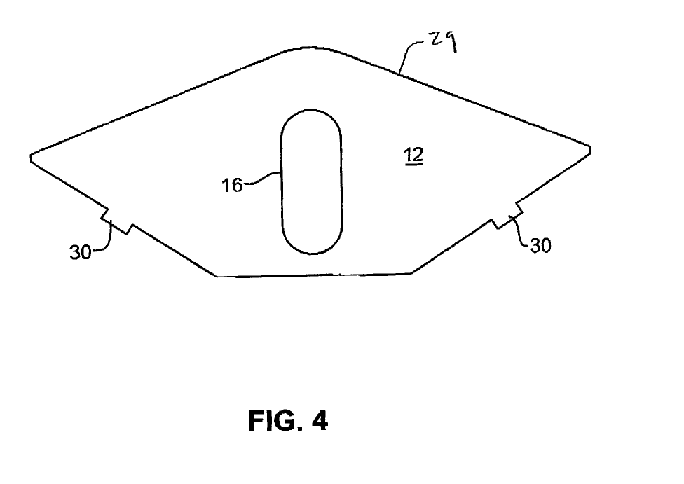

Referring to FIGS. 3 and 4, the guide wall 14 includes a pair of notches 26 configured within a bottom edge 28 ofthe guide wall 14. The notches 26 correspond to respective tabs 30 in the base 12 which act as keys to properly and consistently position the base 12 relative to the guide wall 14 during manufacture. With the tabs 30 positioned within the notches 26, the guide wall 14 can be welded to the base 12.

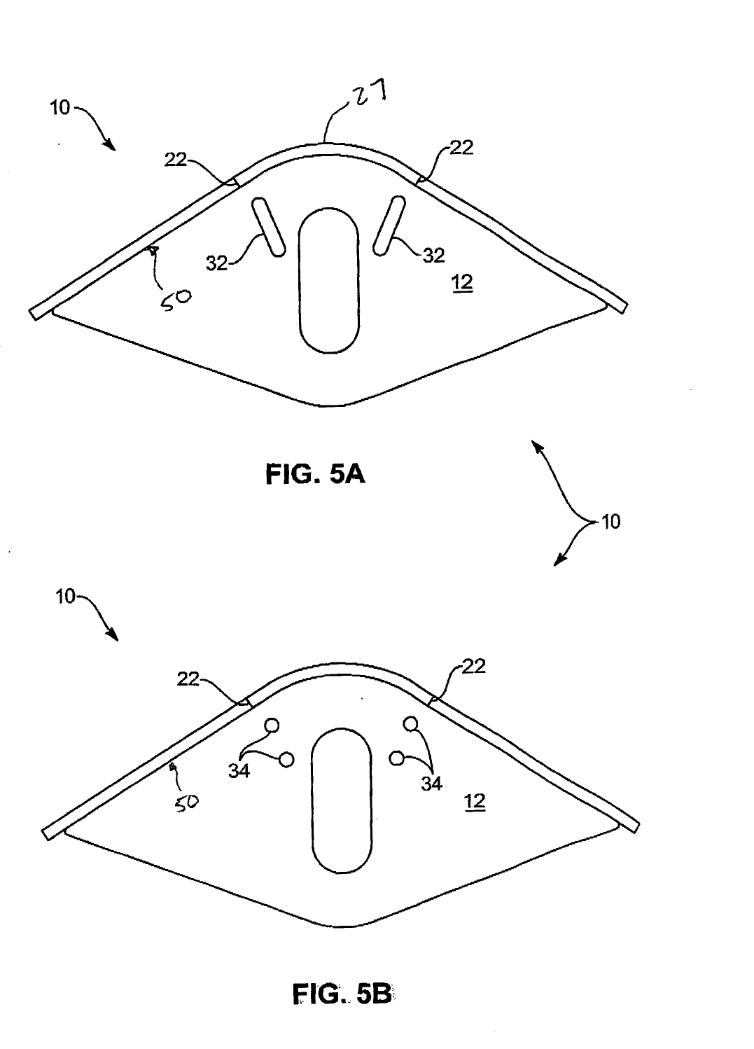

Referring now to FIGS. 5a and 5b, slots 32, holes 34, or other openings may be configured within the base 12 to allow case-hardened bolts, cotter pins, or other fasteners to be positioned within the slots 32 or holes 34. In this way, if it is desired to attach the device 10 to a top side ofthe tow bar 15, the bolts or other fasteners positioned within the slots 32 or holes 34 and extending beneath the base 12 would serve the same function as the edges 22 to prevent the device 10 from rotating. The angled slots 32 allow for fasteners to be positioned within the slots 32 close to the outer edges of the tow bar 15 for a variety of tow bar 15 widths. Likewise, a variety of holes 34 may be positioned to allow fasteners to extend beneath the device 10 and be closely positioned adjacent the edges ofthe tow bar 15 for a variety of standard bar sizes which are usually 2.5 or 3 inches wide. The holes 34 or slots 32 may also be positioned to accommodate non standard tow bar sizes.

In assembly and in operation, the guide 10 may be formed of a base 12 shaped in a convenient manner to be a rectangle, diamond, triangle or the like. In certain embodiments, the base 12 may be provided with a lip 42 along an edge 44 configured to align the base 12 and secure the base 12 to resist rotation. Likewise, the edges 22 ofthe aperture 18 may fit in close proximity to the tow bar 15. The lip 42 and the edges 22, either individually or together, operate as stops effective to resist any substantial rotation ofthe base 12 in response to forces of a trailer tongue against the wall 14.

For example, a trailer tongue striking the left side wall 25a or side portion 25a exerts a force tending to rotate the wall 14 clockwise with respect to the hitch 13, from a plan view. Such rotation or pivoting undermines the alignment effect ofthe wall 14. Accordingly, the nut 46 may be tightened against the base 12 on the bolt 48. However, the frictional effect of clamping the base 12 between the nut 46 and the tow bar 15, to resist rotation about the bolt 46, has a mechanical disadvantage compared to the trailer tongue striking a side wall 25. Therefore, the friction imposed by the nut 46 is normally inadequate to maintain the position of the base 12 and wall 14 to effectively guide a trailer tongue.

By contrast, a stop 22, 42 or registration member 22, 42, such as the edge 22 or the lip 42 operates to provide a second location in addition to the bolt 48 through the aperture 16. Thus, stabilized by two comparatively distant and comparative solid obstructions, the base 12 is unlikely to rotate out of its properly registered position for guiding the trailer tongue towards the hitch 13 in close proximity to the vertex 27 of the wall 14.

In alternative embodiments, slots 32 may receive studs, bolts or other fasteners, shared to rigidly fix the rotation ofthe base 12 with respect to the tow bar 15. Similarly, rods 34, studs 34, pins 34, bolts 34, and the like, may protrude from the base 12 to engage the tow bar 15 to resist rotation there between. In yet another embodiment, the slots 32 may receive bolts, pins, U-bolts, brackets, or the like fitted to the base 12 and the tow bar 15, yet permanently fixed to neither the base 12 nor the tow bar 15. In general, registration members 22, 34, 42 may include any combination of edges 22, apertures 32 pins 34, lips 42, or combinations thereof fixed or fastened, permanently or temporarily to the base 12, or the tow bar 15, in a way to engage the other ofthe tow bar 15 or the base 12. Welding the base 12 to the tow bar 15 presents yet another embodiment. In order to provide an optional or after market apparatus 10 for use on a wide variety of tow bars 15, a free base 12, selectively securable and removable to the tow bar 15 by the nut 46 may provide great practicality and wide spread applicability.

As a practical matter, the wall 14, may be aligned with the base 12 by registering the tabs 30 with the slots 26. The tabs 30 and slots 26 may be reversed with respect to the base 12 and wall 14, if desired. Structural integrity may best be served by a welding bead 50, run along the edge 28 ofthe wall 14 and the edge 29 ofthe base 12. Alternatively, other fastening systems such as bolts, screws, flanges, brackets, and the like may serve adequately. However, welding provides substantially reduced sizes with increased structural integrity by comparison with other fastening mechanisms.

In certain embodiments, the base 12 may fit below the tow bar 15. The placement ofthe base 12 below the underside 17 ofthe tow bar 15 places the edge 22 ofthe wall 14 in a position to bear directly against the tow bar 15. Accordingly, the load of a trailer tongue striking the wall 14 provide a moment about the bolt 48, resisted by the edge 22 through the solid contiguous material ofthe wall 14. The impact ofthe edge 22 comes directly from the wall 14 and the trailer tongue impinging thereon. Thus, the structural integrity and the resistance to impact load is improved. The base 12, being captured within the wall 14 likewise exerts a force against the wall 14 directly to maintain the couple (rotational force) about the bolt 48. Thus the weld 50 is not severely loaded.

To accommodate the forgoing structure, it may be convenient to leave open a region between the vertex 27 or center portion 27 ofthe wall 14 and the rear edge 29 ofthe base 12 to form an aperture 52 in the base 12. This aperture 52 is not required but may be convenient, to enlarge the aperture 18 during installation and sacrifices little structural integrity since the edge 29 of the base 12 cannot weld to the edge 28 of the wall 14 under the vertex 27 anyway.

The aperture 52 combines with the aperture 18 to form a suitable opening to receive the tow bar 15. The combination may be referred to as the aperture 18 as a practical matter. The aperture 18, thus is a closed aperture, thus maintaining better structural integrity under load and complete capture during assembly (installation on a vehicle), as well as providing proper alignment.

Without closure ofthe aperture 18, the edges 22 might deflect and deform at lower loads. Thus, although the apparatus 10 is selectively removable from a tow bar 15, installation may effectively be substantially permanent for a user. This degree of selective permanence provides convenience for a user by not requiring repeated handling, manipulation for installation and removal, or storage.

Handling (carrying, lifting, etc.) the apparatus 10 as well as manipulating (adjusting, sliding, shifting, rotating, fitting, etc.) a large, rusty, dirty, greasy, heavy apparatus 10, several years after purchase, loses a lot of its initial charm, its utility notwithstanding. Finding storage space and moving the apparatus 10 to and from that storage space only further complicates ownership and use ofthe apparatus 10.

In this embodiment, the user simply backs the hitch 13 and guide 10 toward a trailer tongue. The trailer tongue is captures between the sidewalls 25a, 25b, each providing a force, as appropriate urging the trailer tongue there along toward the vertex 27. Any comparatively large lateral motion ofthe trailer tongue between the walls 25a, 25b results in impingement ofthe trailer tongue against the opposite wall 25b, 25a. Once captured, the trailer tongue either slide along a wall 25a, 25b, or possibly dithers between the walls 25a, 25b as it move inexorably forward toward alignment with the hitch 13 near the vertex 27. At the this point, the trailer tongue may be lowered over the hitch 13 without any further manipulation.

The simple design is stronger than prior art designs and less expensive to manufacture. It is also easier for a consumer to use. The device 10 does not have to be removed before securing the ball 13 to the trailer tongue or before securing the ball hitch to the receiver. The high guide wall 14 also provides protection for the vehicle.

It should be appreciated that the apparatus ofthe present invention is capable of being incorporated in the form of a variety of embodiments, only a few of which have been illustrated and described above. The invention may be embodied in other forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. A guide for directing a trailer tongue with respect to a hitch, the guide comprising:
a base positioned below the tow bar, having a first aperture for receiving the hitch there through, the hitch securable to the base and the tow bar;
a wall, secured to the base and having a second aperture, the wall being located toward a front of the base to receive the tow bar through the second aperture to extend rearwardly therefrom over the base; and
the wall further comprising side portions extending outwardly and rearwardly from a center portion contiguous therebetween, the side portions each positioned to urge the trailer tongue toward the other as the trailer tongue moves forward relative to the wall.

2. The guide of claim 1, wherein the wall is one integral piece.

3. The guide of claim 1, wherein the side portions are connected to the center portion to extend tangentially therefrom, and the center portion has a diameter larger than the width ofthe tongue of the trailer.

4. The guide of claim 1, wherein the second aperture resists pivoting ofthe guide with respect to the tow bar.

5. The guide of claim 1, wherein the wall is positioned forward ofthe hitch relative to a vehicle to which the hitch is attached.

6. The guide of claim 1, wherein the base has a pair of extensions near the second aperture alongside the tow bar and eliminating any pivoting movement ofthe guide in relation to the tow bar.

7. The guide of claim 1, wherein the first aperture is elongated to allow movement of the hitch within the first aperture.

8. The guide of claim 1, wherein the wall has a height greater than about two inches.

9. The guide of claim 1, wherein the wall has a height less than about ten inches.

10. The guide of claim 1, wherein the wall has a height of about seven inches.

11. The guide of claim 1, further comprising registration members to resist rotation of the guide member relative to the tow bar.

12. The guide of claim 11, wherein the registration member is lip extending downward from the base, the lip configured to engage a bumper.

13. The guide of claim 11, wherein the registration member is a side edge ofthe second aperture.

14. The guide of claim 1, wherein the registration member is a fastener positioned through an opening in the base.

15. The guide of claim 1 wherein the wall in configured with at least one notch for engagement with a corresponding tab configured within the base for alignment between the wall and the base to facilitate securing the wall to the base.

16. A guide for directing a trailer tongue with respect to a hitch, the guide comprising:
a base having a first aperture for receiving the hitch there through, the hitch securable to the base and the tow bar;
a wall, secured to the base and having a second aperture, the wall being located toward a front of the base to receive the tow bar through the second aperture to extend rearwardly therefrom over the base;
the wall further comprising side portions extending outwardly and rearwardly from a center portion contiguous there between, the side portions each positioned to urge the trailer tongue toward the other as the trailer tongue moves forward relative to the wall; and
at least one registration member positioned to resist rotation ofthe guide member relative to the tow bar.

17. The guide of claim 16, wherein the registration member is lip extending downward from the base, the lip configured to engage a bumper.

18. The guide of claim 16, wherein the registration member is a side edge ofthe second aperture.

19. The guide of claim 16, wherein the registration member is a fastener positioned through an opening in the base.

20. A guide for directing a trailer tongue with respect to a hitch, the guide comprising:
a base positioned below the tow bar, having a first aperture for receiving the hitch there through, the hitch securable to the base and the tow bar;
a wall, secured to the base and having a second aperture, the wall being located toward a front of the base to receive the tow bar through the second aperture to extend rearwardly therefrom over the base; and
the wall further comprising side portions extending outwardly and rearwardly from a center portion contiguous therebetween, the side portions each positioned to urge the trailer tongue toward the other as the trailer tongue moves forward relative to the wall, and wherein the center portion has a diameter larger than the width of the tongue of the trailer.
